(19) United States
(12) Patent Application Publication
(10) Pub. No.: US 2020/0332822 A1
(43) Pub. Date: Oct. 22, 2020

(54) SCREW STRUCTURE

(71) Applicant: INTEGRAL BUILDING PRODUCTS INCORPORATION, TAINAN CITY (TW)

(72) Inventor: LI-CHING HSIAO, TAINAN CITY (TW)

(21) Appl. No.: 16/389,022

(22) Filed: Apr. 19, 2019

(51) Int. Cl. F16B 25/00

(52) U.S. Cl. CPC F16B 25/0057; F16B 25/0073; F16B 25/0015

(57) ABSTRACT

A screw structure is disclosed herein. It comprises a rod part, an upper thread part on a periphery of an upper portion of the rod part and having plural thread pitches, a lower thread part on a periphery of a lower portion of the rod part for connecting the upper thread part and having an outer diameter less than an outer diameter of the upper thread part, and a plurality of beveling tangent planes on the periphery of the lower portion of the rod part, wherein the upper thread part forms a first lead angle of 5-15 degrees and a second lead angle of 20-30 degrees, and wherein the first and second lead angles of the upper thread part at a starting point in each of the plural thread pitches are opposite to the first and second lead angles of the upper thread part at a 180-degree position.

### BACKGROUND OF THE INVENTION

### 1. Field of the Invention

The present invention relates to a screw structure which can prevent the wood shavings from splashing outward to reduce the environmental mess, increase the adhesion between a screw and a wood material to achieve an excellent anti-loose effect, and reduce the resistance of the drilling to increase the smoothness of the drilling process so that it can be applied to screw into various wood materials to decrease the occurrence of wood cracking or screw breakage and save time and effort during use.

### 2. Description of Related Art

Generally, the screws have different functions according to different thread arrangements, screw lengths and pitches. A common screw structure comprises an integrally formed head, a rod body, a beveling tangent screw thread wrapping on a periphery of the rod body, and a tip. The head is formed at one end of the rod body, and the tip is formed at the other end of the rod body. In this way, the head drives the rod body to rotate by various tools, and the tip is screwed into an object by the beveling tangent screw thread wrapping on the periphery of the rod body.

Although the abovementioned screw structure achieves the intended effects of screwing and drilling the object, it still has disadvantages in a practical use as following:

1. The conventional screw structure cannot collect wood shavings during drilling process, so the wood shaving will splash out, resulting in environmental mess, decreased adhesion between the screw and the wood materials, and loosening of the screw.

2. The resistance will be increased greatly during the drilling of the conventional screw structure as the increases of the drilling depth, resulting in a lower smoothness of the drilling process. Therefore, it is not suitable for drilling wood with high density and high hardness, which usually requires drilling with a drill bit in advance.

### SUMMARY OF THE INVENTION

In view of the above-mentioned problems, the object of the present invention is to provide a screw structure which can prevent the wood shavings from splashing outward to reduce the environmental mess, increase the adhesion between a screw and a wood material to achieve an excellent anti-loose effect, and reduce the resistance of the drilling to increase the smoothness of the drilling process so that it can be applied to screw into various wood materials to decrease the occurrence of wood cracking or screw breakage and save time and effort during use.

### BRIEF DESCRIPTION OF THE DRAWINGS

FIG. 1 is a stereogram showing a screw structure according to the present invention;

FIG. 2 is a cross-sectional view showing a screw structure according to the present invention;

FIG. 3 is a partial enlarged cross-sectional view showing a screw structure according to the present invention;

FIG. 4 is a partial stereogram showing a screw structure according to the present invention.

### DETAILED DESCRIPTION OF THE PREFERRED EMBODIMENT

Hereinafter, an exemplary embodiment of the present invention will be described in detail with reference to the accompanying drawings.

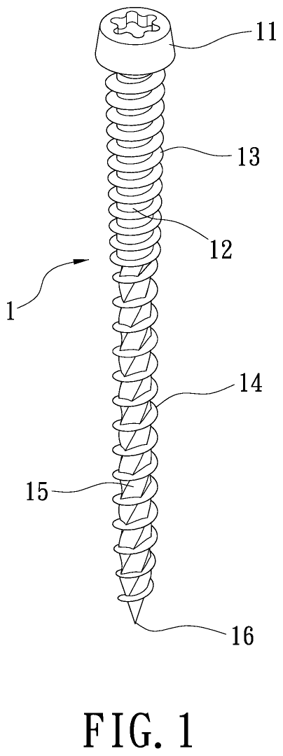

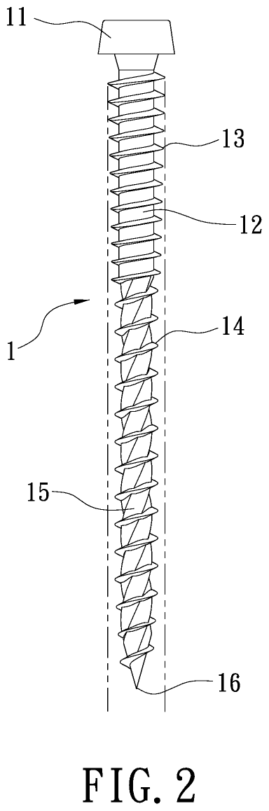

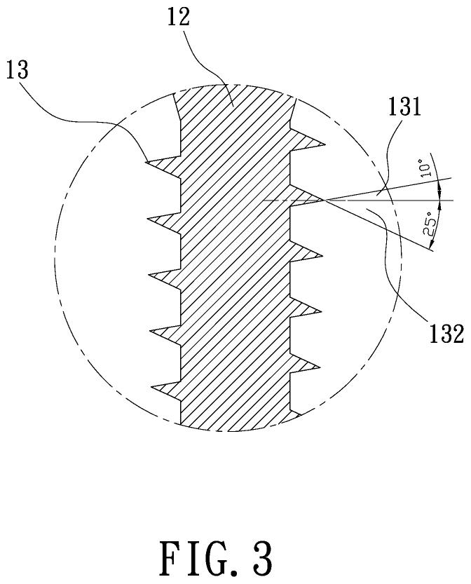

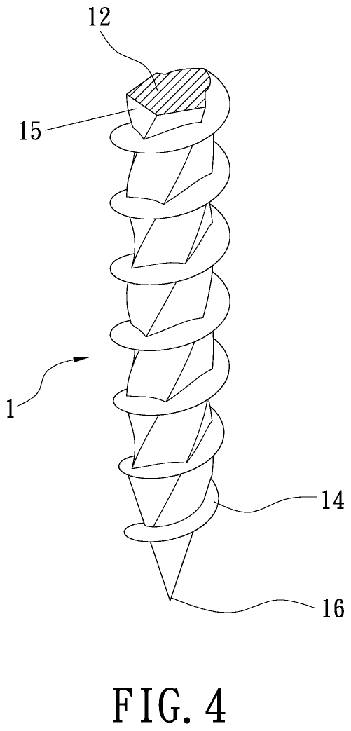

As showed in FIG. 1 and FIG. 2, a stereogram and a cross-sectional view of a screw structure according to the present invention are respectively disclosed herein. A screw (1) comprises a head (11), a rod part (12), an upper thread part (13), a lower thread part (14), a plurality of beveling tangent planes (15) and a tip (16). The head (11) of the screw (1) can be rotated by various hand tools, electric tools and the like to screw into an object. The rod part (12) is connected at a lower end of the head (11). The upper thread part (13) is formed on a periphery of an upper portion of the rod part (12) and has plural thread pitches. Referring to FIG. 3, the upper thread part (13) forms a first lead angle (131) of 5-15 degrees (preferably 10 degrees) between a first line extending upward from a lower edge thereof and a vertical line of the rod part (12) and a second lead angle (132) of 20-30 degrees (preferably 25 degrees) between a second line extending downward from a upper edge thereof and the vertical line of the rod part (12). The first lead angle (131) and the second lead angle (132) of the upper thread part (13) at a starting point in each of the plural thread pitches are opposite to the first lead angle (131) and the second lead angle (132) of the upper thread part (13) at a 180-degree position. The lower thread part (14) is formed on a periphery of a lower portion of the rod part (12) and connected to the upper thread part (13). The lower thread part (14) has an outer diameter less than an outer diameter of the upper thread part (13). Referring to FIG. 4, a partial stereogram showing a screw structure according to the present invention is disclosed herein. The plurality of beveling tangent planes (15) is formed on the periphery of the lower portion of the rod part (12). Preferably, the screw (1) comprises five beveling tangent planes (15). The tip (16) is formed at a bottom end of the rod part (12).

Accordingly, in practical use of the present invention, the tip (16) of the screw (1) is correspondingly screwed into a predetermined position of a wood material by a hand tool or an electric tool for driving the head (11) of the screw (1) to rotate, so that the tip (16) of the screw (1) is drilled into the wood material. After the tip (16) is drilled into the wood material, the upper thread part (13) and the lower thread part (14) formed on the periphery of the rod part (12) jointly cut and drill the wood material, so that the screw (1) is completely drilled into the wood material to firmly fix to the wood material.

According to the above description, in comparison with the traditional technique, the screw structure according to the present invention has the advantages as following:

1. The upper thread part of the present invention can gather and compress the cut wood shavings into the thread pitches of the upper thread part to prevent the wood shavings from splashing outward, reduce the environmental mess, increase the density of wood shavings gathered in the thread pitches, and increase the adhesion between the screw and the wood material to achieve an excellent anti-loose effect.

2. The lower thread part of the present invention cooperating with the design of the plural beveling tangent planes reduce the resistance of the drilling process and increase the smoothness during drilling, so the screw structure is applicable to various wood materials. Even if the screw structure is screwed into the wood material of high density and high hardness, the cracking of the wood or the breakage of the screw can be reduced, which greatly saves time and effort in use.

What is claimed is:

1. A screw structure, comprising:
a head;
a rod part connected at a lower end of the head;
an upper thread part formed on a periphery of an upper portion of the rod part and having plural thread pitches, wherein the upper thread part forms a first lead angle of 5-15 degrees between a first line extending upward from a lower edge thereof and a vertical line of the rod part and a second lead angle of 20-30 degrees between a second line extending downward from a upper edge thereof and the vertical line of the rod part, and wherein the first lead angle and the second lead angle of the upper thread part at a starting point in each of the plural thread pitches are opposite to the first lead angle and the second lead angle of the upper thread part at a 180-degree position;
a lower thread part formed on a periphery of a lower portion of the rod part for connecting the upper thread part and having an outer diameter less than an outer diameter of the upper thread part;
a plurality of beveling tangent planes formed on the periphery of the lower portion of the rod part; and
a tip at a bottom end of the rod part.

2. The screw structure as claimed in claim 1, wherein the first lead angle of the upper thread part is 10 degrees.

3. The screw structure as claimed in claim 1, wherein the second lead angle of the upper thread part is 25 degrees.

4. The screw structure as claimed in claim 1, comprising five beveling tangent planes.
